(19) United States
(12) Patent Application Publication
(10) Pub. No.: US 2026/0370526 A1
(43) Pub. Date: Nov. 19, 2026

(54) COMBINED WAVEFORMS FOR SIGNAL MODULATION

(71) Applicant: QUALCOMM Incorporated, San Diego, CA (US)

(72) Inventors: June NAMGOONG, San Diego, CA (US); Jing JIANG, San Diego, CA (US); Wei YANG, San Diego, CA (US); Akash Sandeep DOSHI, San Diego, CA (US); Tingfang JI, San Diego, CA (US); Juergen CEZANNE, Ocean Township, NJ (US); Vinayak SURESH, San Diego, CA (US)

(21) Appl. No.: 19/209,684

(22) Filed: May 15, 2025

(51) Int. Cl. H04L 27/20; H04L 27/26; H04L 41/16

(52) U.S. Cl. CPC H04L 27/2085; H04L 27/2636; H04L 41/16

(57) ABSTRACT

Various aspects of the present disclosure generally relate to wireless communication. In some aspects, waveform design for wireless communication may enable a reduction in peak-to-average power ratio (PAPR). In some aspects, a wireless communication device may transmit an uplink signal using a combined waveform that may be constructed based on a π/2-BPSK modulation scheme by combining two waveforms to achieve lower PAPR. The first waveform may be generated according to a π/2-BPSK modulation scheme, which includes applying a first sequence delay for a sequence of even-numbered symbols that is up-sampled and rotated in phase by π/2, and a second sequence delay for a sequence of odd-numbered symbols that is up-sampled. The second waveform further reduces PAPR by employing a modulation scheme that include applying first and second functions to sets of adjacent bits, and up-sampling these values.

### FIELD OF THE DISCLOSURE

Aspects of the present disclosure generally relate to wireless communication and specifically relate to techniques, apparatuses, and methods associated with combined waveforms for signal modulation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, waveform construction may be used for data transmission. Waveform construction may include the transformation of coded bits into modulated symbols, followed by spectral shaping to adapt a signal to transmission guidelines or specifications. Techniques such as discrete Fourier transform and circular convolution may be used to generate frequency domain samples for transmission via a communication channel. Advanced waveform construction incorporates methods like machine learning and gradient-based optimization to refine performance characteristics.

### SUMMARY

The systems, methods, and devices of this disclosure each have several innovative aspects, no single one of which is solely responsible for the desirable attributes disclosed herein.

Some aspects described herein relate to a wireless communication device. The wireless communication device may include a processing system. The processing system may include one or more processors and one or more code-storing memories coupled with the one or more processors. The processing system may be configured to cause the wireless communication device to generate a first waveform according to a π/2-binary phase shift keying (BPSK) modulation scheme that include applying a first sequence delay for a sequence of even-numbered symbols, of the first waveform, that is up-sampled and rotated in phase by π/2, and a second sequence delay for a sequence of odd-numbered symbols, of the first waveform, that is up-sampled. The processing system may be configured to cause the wireless communication device to generate a second waveform by, applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted. The processing system may be configured to cause the wireless communication device to transmit a composite waveform that includes the first waveform and the second waveform.

Some aspects described herein relate to a method for wireless communication by a wireless communication device. The method may include generating a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled. The method may include generating a second waveform by, applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted. The method may include transmitting a composite waveform that includes the first waveform and the second waveform.

Some aspects described herein relate to a non-transitory computer-readable medium that stores a set of instructions for wireless communication by a wireless communication device. The set of instructions, when executed by one or more processors of the wireless communication device, may cause the wireless communication device to generate a first waveform according to a π/2-BPSK modulation scheme that include applying a first sequence delay for a sequence of even-numbered symbols, of the first waveform, that is up-sampled and rotated in phase by π/2, and a second sequence delay for a sequence of odd-numbered symbols, of the first waveform, that is up-sampled. The set of instructions, when executed by one or more processors of the wireless communication device, may cause the wireless communication device to generate a second waveform by, apply the first sequence delay to a first sequence of values, each value in the first sequence of values being a first function of an even-numbered set of adjacent bits that is up-sampled, and apply the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted. The set of instructions, when executed by one or more processors of the wireless communication device, may cause the wireless communication device to transmit a composite waveform that includes the first waveform and the second waveform.

Some aspects described herein relate to an apparatus for wireless communication. The apparatus may include means for generating a first waveform according to a π/2-BPSK modulation scheme that include applying a first sequence delay for a sequence of even-numbered symbols, of the first waveform, that is up-sampled and rotated in phase by π/2, and a second sequence delay for a sequence of odd-numbered symbols, of the first waveform, that is up-sampled. The apparatus may include means for generating a second waveform by, means for applying the first sequence delay to a first sequence of values, each value in the first sequence of values being a first function of an even-numbered set of adjacent bits that is up-sampled, and means for applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted. The apparatus may include means for transmitting a composite waveform that includes the first waveform and the second waveform.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a transmit chain and a receive chain of a wireless communication device.

FIGS. 3A-3D are diagrams illustrating an example associated with combined waveforms for signal modulation.

FIG. 4 is a flowchart illustrating an example process performed, for example, at a wireless communication device or an apparatus of a wireless communication device that supports combined waveforms for signal modulation.

FIG. 5 is a diagram of an example apparatus for wireless communication that supports combined waveforms for signal modulation.

### DETAILED DESCRIPTION

In wireless communication systems, modulation schemes, such as binary phase shift keying (BPSK), are commonly used to encode data for transmission. Modulation varies a carrier signal to transmit data. In BPSK, each bit of data is represented by one of two phases of the carrier signal, typically 0 and 180 degrees. One specific variant, π/2-BPSK, enables a relatively reduced peak-to-average power ratio (PAPR). In π/2-BPSK, the phase of the carrier signal shifts by 90 degrees (π/2 radians) between consecutive symbols.

Lowering PAPR may enhance power efficiency and reduce the likelihood of signal distortion during transmission. PAPR is the ratio of the peak power of the signal to its average power. High PAPR signals can cause power amplifiers to operate inefficiently, leading to non-linear distortion and spectral regrowth, which can interfere with adjacent channels and degrade overall system performance. However, even with π/2-BPSK, challenges remain in achieving a low PAPR.

Traditional waveform construction methods for π/2-BPSK involve encoding N coded bits to be transmitted over N resource elements (REs). These bits are converted into BPSK symbols, which are then modulated and transformed into the frequency domain using techniques such as the discrete Fourier transform (DFT). To further shape the spectrum and reduce PAPR, a spectral shaping window is applied either in the frequency domain or in the time domain through circular convolution with an impulse response derived from the inverse DFT (IDFT) of the shaping window.

In practical implementations, the spectral shaping alone may not adequately reduce the PAPR to levels for relatively increased performance. Consequently, systems that rely solely on these traditional techniques may experience suboptimal power efficiency and increased signal distortion. This is particularly pertinent in scenarios where efficient power usage and high signal integrity are paramount, such as in low signal-to-noise ratio (SNR) environments or when dealing with limited power budgets.

Moreover, the design and optimization of pulse shaping filters may consider various parameters to ensure that the desired performance metrics are met. Traditional approaches may not fully exploit the potential of advanced optimization techniques, leading to sub-optimal filter designs that fail to minimize PAPR. Additionally, some traditional designs may not sufficiently address the trade-offs between PAPR reduction and other performance metrics, such as spectral efficiency and mutual information.

Various aspects relate generally to waveform design for wireless communication to reduce PAPR. Some aspects more specifically relate to a wireless communication device transmitting an uplink signal using a combined waveform that is constructed based on a π/2-BPSK modulation scheme by combining two waveforms to achieve lower PAPR. The first waveform is generated according to a π/2-BPSK modulation scheme, which includes applying a first sequence delay for a sequence of even-numbered symbols that is up-sampled (for example, by a factor of 2) and rotated in phase by π/2, and a second sequence delay for a sequence of odd-numbered symbols that is up-sampled. The second waveform further reduces PAPR (for example, PAPR is further reduced relative to the PAPR reduction in accordance with the π/2-BPSK modulation scheme) by employing a modulation scheme that include applying first and second functions to sets of adjacent bits (for example, related to lookup tables), and up-sampling these values. For example, the lookup table for each respective function may be a complex valued lookup table that maps bit sequences to corresponding modulation values that may be optimized to result in a reduced PAPR. The first function may process even-numbered sets of adjacent bits, and the second function may process odd-numbered sets of adjacent bits, thereby enabling a set of values resulting from the second function to be delayed (for example, by one sample) at a different delay from a set of values resulting from the first function.

In some aspects, the first and second waveforms are summed, and DFT is applied to the summed waveforms. In this way, the resulting composite waveform may be transmitted with a relatively reduced PAPR. The first function and the second function can be generated using machine learning (ML) algorithms or gradient-based refinement procedures to optimize the waveform.

Particular aspects of the subject matter described in this disclosure can be implemented to realize one or more of the following potential advantages. In some examples, by generating and combining the first and second waveforms as described, the techniques can effectively reduce the PAPR of the transmitted signal. This reduction in PAPR enhances power efficiency and reduces the likelihood of signal distortion during transmission, thereby maintaining high signal integrity, especially in low SNR environments or when operating with limited power budgets. In this way, communicating using the combined waveform may conserve power resources and improve signal integrity in wireless communication systems.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or ML (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

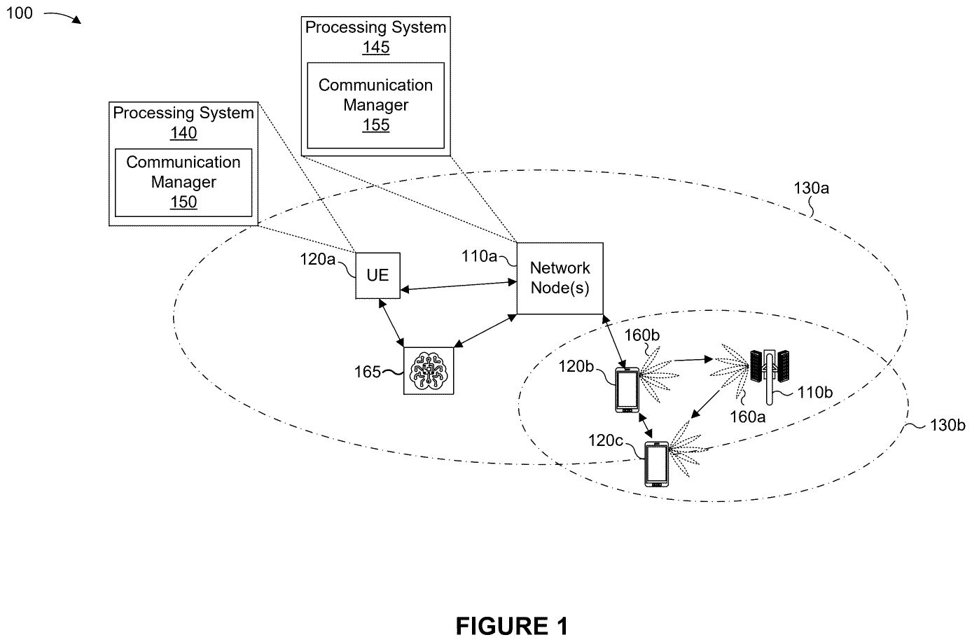

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and REs), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a DFT-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes an ML model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the wireless communication device (for example, a UE 120 or a network node 110) may include a communication manager (for example, communication manager 150 or communication manager 155). As described in more detail elsewhere herein, the communication manager 150 may generate a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled; generate a second waveform: applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted; and transmit a composite waveform that includes the first waveform and the second waveform. Additionally or alternatively, the communication manager may perform one or more other operations described herein.

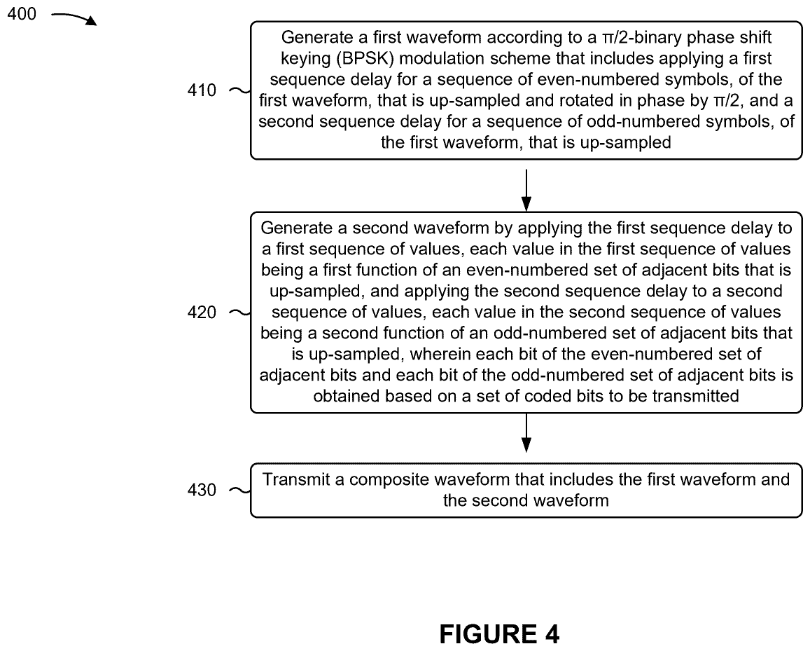

The wireless communication device (for example, the network node 110 or the UE 120) or the processing system of the wireless communication device (for example, the processing system 145 of the network node 110, or the processing system 140 of the UE 120), or any other component(s) of FIG. 1 may implement one or more techniques or perform one or more operations associated with combined waveforms for signal modulation, as described in more detail elsewhere herein. For example, the processing system 145 of the network node 110, or the processing system 140 of the UE 120, may perform or direct operations of, for example, process 400 of FIG. 4 or other processes as described herein (alone or in conjunction with one or more other processors). In some aspects, the wireless communication device described herein is the network node 110, is included in the network node 110, or includes one or more components of the network node 110 shown in FIG. 1. In some aspects, the wireless communication device described herein is the UE 120, is included in the UE 120, or includes one or more components of the UE 120 shown in FIG. 1. Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4 or other processes as described herein. In some examples, executing instructions may include running the instructions, converting the instructions, compiling the instructions, or interpreting the instructions, among other examples.

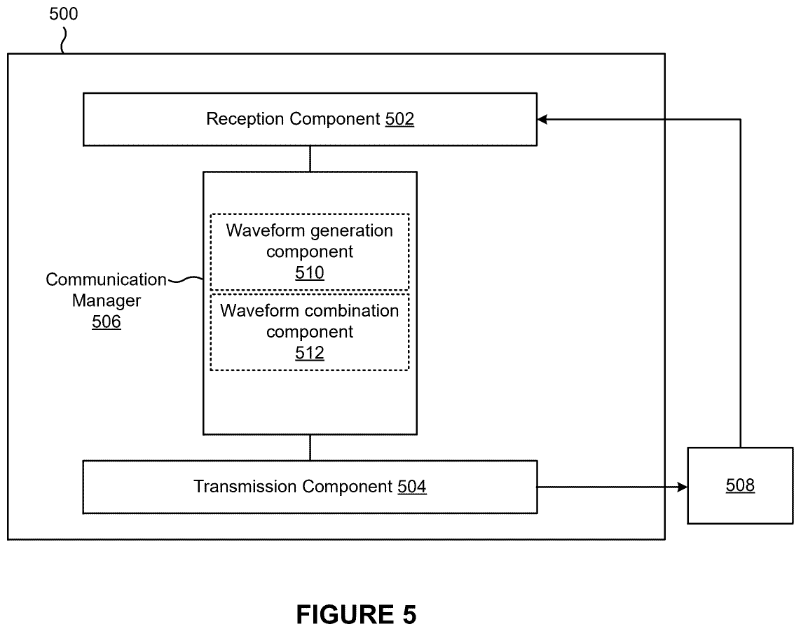

In some aspects, the wireless communication device (for example, the UE 120 or the network node 110) includes means for generating a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled; means for generating a second waveform that includes: means for applying the first sequence delay to a first sequence of values, each value in the first sequence of values being a first function of an even-numbered set of adjacent bits that is up-sampled, and means for applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted; or means for transmitting a composite waveform that includes the first waveform and the second waveform. The means for the wireless communication device to perform operations described herein may include, for example, one or more of communication manager 150, communication manager 155, processing system 140, processing system 145, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples.

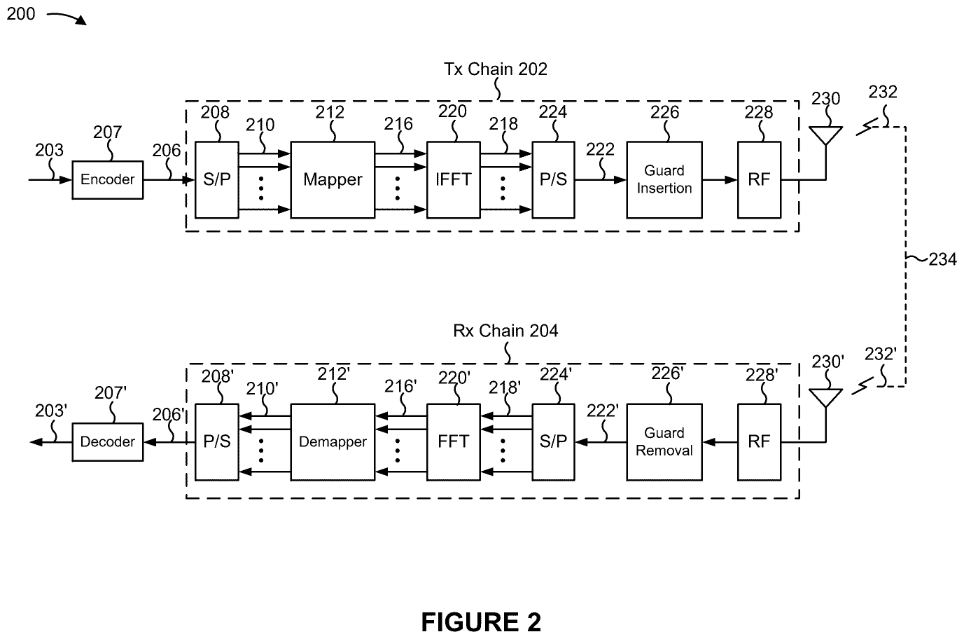

FIG. 2 is a diagram illustrating an example 200 of a transmit (Tx) chain 202 and a receive (Rx) chain 204 of a wireless communication device (for example, UE 120 or network node 110). In some aspects, one or more components of Tx chain 202 may be implemented in one or more components of a processing system, such as the processing system 140 described in connection with FIG. 1. In some aspects, Tx chain 202 may be implemented in the wireless communication device (for example, UE 120 or network node 110) for transmitting data 206 (for example, uplink data, an uplink reference signal, uplink control information, downlink data, a downlink reference signal, or downlink control information) to a different wireless communication device (for example, UE 120 or network node 110) via an uplink channel or a downlink channel.

An encoder 207 may alter a signal (for example, a bitstream) 203 into data 206. Data 206 to be transmitted is provided from encoder 207 as input to a serial-to-parallel (S/P) converter 208. In some aspects, S/P converter 208 may split the transmission data into N parallel data streams 210.

The N parallel data streams 210 may then be provided as input to a mapper 212. Mapper 212 may map the N parallel data streams 210 onto N constellation points. The mapping may be done using a modulation constellation, such as BPSK, quadrature phase-shift keying (QPSK), 8 phase-shift keying (8PSK), quadrature amplitude modulation (QAM), etc. Thus, mapper 212 may output N parallel symbol streams 216, each symbol stream 216 corresponding to one of N orthogonal subcarriers of an IFFT component 220. These N parallel symbol streams 216 are represented in the frequency domain and may be converted into N parallel time domain sample streams 218 by IFFT component 220.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 218 may be converted into an OFDM/OFDMA symbol stream 222 by a parallel-to-serial (P/S) converter 224. A guard insertion component 226 may insert a guard interval between successive OFDM/OFDMA symbols in the OFDM/OFDMA symbol stream 222. The output of guard insertion component 226 may then be upconverted to a desired transmit frequency band by a radio frequency (RF) front end 228. An antenna 230 may then transmit the resulting signal 232.

In some aspects, Rx chain 204 may utilize OFDM/OFDMA. In some aspects, one or more components of Rx chain 204 may be implemented in one or more components of a processing system, such as the processing system 140 described in connection with FIG. 1. In some examples, Rx chain 204 may be implemented in the wireless communication device for receiving data 206 (for example, uplink data, an uplink reference signal, uplink control information, downlink data, a downlink reference signal, or downlink control information) from a different wireless communication device via a downlink channel or an uplink channel.

A transmitted signal 232 is shown traveling over a wireless channel 234 from Tx chain 202 to Rx chain 204. When a signal 232′ is received by an antenna 230′, the received signal 232′ may be downconverted to a baseband signal by an RF front end 228′. A guard removal component 226′ may then remove the guard interval that was inserted between OFDM/OFDMA symbols by guard insertion component 226.

The output of guard removal component 226′ may be provided to an S/P converter 224′. The output may include an OFDM/OFDMA symbol stream 222′, and S/P converter 224′ may divide the OFDM/OFDMA symbol stream 222′ into N parallel time-domain symbol streams 218′, each of which corresponds to one of the N orthogonal subcarriers. A fast Fourier transform (FFT) component 220′ may convert the N parallel time-domain symbol streams 218′ into the frequency domain and output N parallel frequency-domain symbol streams 216′.

A demapper 212′ may perform the inverse of the symbol mapping operation that was performed by mapper 212, thereby outputting N parallel data streams 210′. A P/S converter 208′ may combine the N parallel data streams 210′ into a single data stream 206′. Ideally, data stream 206′ corresponds to data 206 that was provided as input to Tx chain 202. Data stream 206′ may be decoded into a decoded data stream 203′ by decoder 207′.

A wireless communication device (for example, a UE 120 or a network node 110) may transmit a modulated signal to a different wireless communication device (for example, a UE 120 or a network node 110). For example, the wireless communication device may modulate a data stream using phase shift keying (PSK) modulation, such as BPSK or QPSK, among other examples. Additionally or alternatively, the wireless communication device may apply a multiplexing modulation technique to combine a set of data streams into a single signal across a set of orthogonal subcarriers. For example, the wireless communication device may apply OFDM modulation waveforms, such as DFT-s-OFDM or CP OFDM (CP-OFDM), among other examples.

PAPR is a ratio of peak power of a signal to average power of the signal. The PAPR value may be measured for a transmitted signal in an OFDM system. Lower PAPR values may be desirable for achieving efficient performance of a system. For example, lower PAPR values may enable greater power amplifier efficiency, reduced signal distortion, improved battery life, improved spectral efficiency, and higher link reliability and quality of service (QoS), relative to higher PAPR values. Accordingly, some wireless communication devices may select DFT-s-OFDM modulation waveforms, which may achieve lower PAPR values than CP-OFDM modulation achieves under similar conditions. Selecting DFT-s-OFDM may enable a wireless communication device to apply smaller (or no) power backoff relative to selecting CP-OFDM, which may provide for improved coverage. Similarly, some wireless communication devices may select π/2 BPSK (which rotates alternating BPSK symbols by a rotation of π/2), which may achieve lower PAPR values than regular (non-π/2 rotated) BPSK, by reducing an adverse effect of a main sidelobe from adjacent symbols. When using π/2 BPSK, a wireless communication device may apply a frequency domain spectral shaping (FDSS) filter to reduce PAPR and allow the wireless communication device to drive a power amplifier to a saturation level and achieve an output with increased power to enhance coverage.

In some examples, waveform construction for a π/2 BPSK waveform may include N coded bits to be transmitted for N REs, where the bits bₙ∈{0,1}, for n=0, 1, . . . , N−1. The corresponding BPSK symbols dₙ∈{−1,1} are generated according to dₙ=1−2bₙ. Accordingly, the π/2 BPSK waveform in the time domain may be constructed as:

$${s}_{n} = \{ {\sum }_{l - 0}^{\frac{N}{2} - 1} ( {jd}_{2 l} δ ( n - 2 l ) + {d}_{2 l + 1} δ ( n - 2 l - 1 ) ) \} ,$$

for n=0, 1, . . . , N−1, where sₙ is the π/2 BPSK waveform, N is a quantity of coded bits to be transmitted, l is an integer, j is a unit imaginary number, a first symbol delay is 2l, a second symbol delay is 2l±1, d₂ₗ is a 2l^{th} BPSK symbol transmitted at the first symbol delay, d₂ₗ₊₁ is a (2l+1)th BPSK symbol transmitted at the second symbol delay, n is an integer time index ranging from 0 to N−1, and δ(n) is a discrete time impulse function.

Furthermore, the N-point DFT may be performed on N samples sₙ to obtain N-point frequency domain samples Sₖ to be transmitted on N REs (k=0, 1, . . . , N−1). A spectral shaping window of length N, denoted by Pₖ, may be applied to Sₖ to obtain PₖSₖ to be sent on the k-th RE. Similarly, the spectral shaping window may be applied in the time domain by performing a circular convolution of sₙ with the time domain impulse response, pₙ, obtained from an IDFT of Pₖ, where the RE symbols are obtained from a DFT of sₙ*pₙ.

In some examples, when generating a waveform for transmission using rank-2 π/2 BPSK with an FDSS filter, a wireless communication device may map DMRS REs for each layer in an orthogonal manner. In other words, a wireless communication device may map even-indexed REs to a first layer and odd-indexed REs to a second layer in a frequency domain to enable channel estimation to be performed on a per-layer basis. To generate a waveform, the wireless communication device may perform a set of operations, such as the layer mapping, DFT precoding and FDSS filtering, precoding, subcarrier mapping, and IFFT processing. The wireless communication device may map modulated data symbols to antenna ports based on generating the waveform and may transmit the waveform from the antenna. At a receive side, the other wireless communication device may reverse the set of operations to recover a data stream.

In wireless systems (for example, wireless systems utilizing OFDM), a signal can exhibit large peaks due to the constructive interference of multiple subcarriers, which may lead to a high PAPR. High PAPR can cause reduced efficiency for power amplifiers, and increased signal distortion. Further, high PAPR may cause a higher dynamic range during signal conversion, which may in turn increase cost, complexity, and power consumption of UE or network node operations.

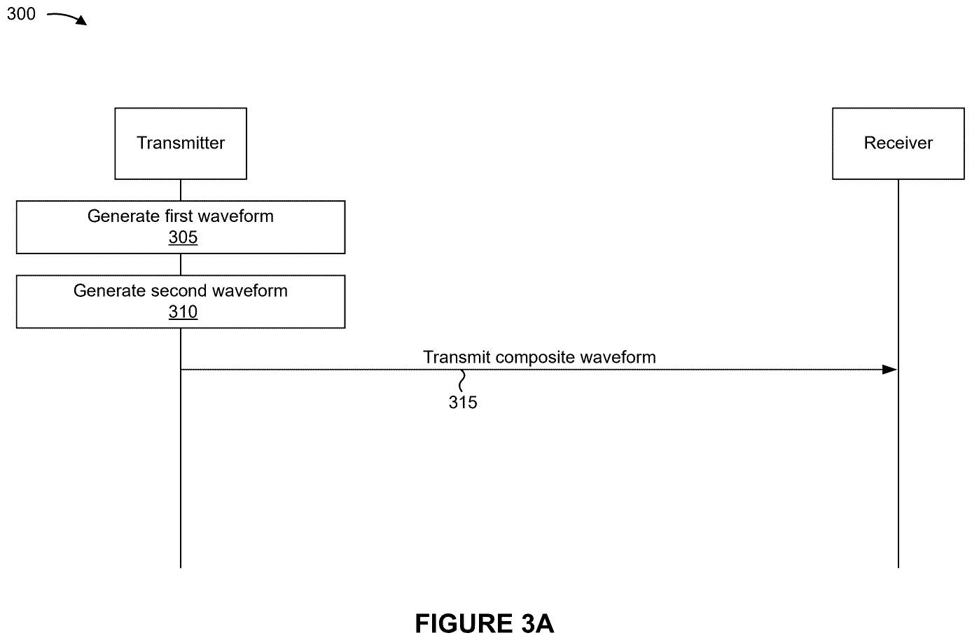

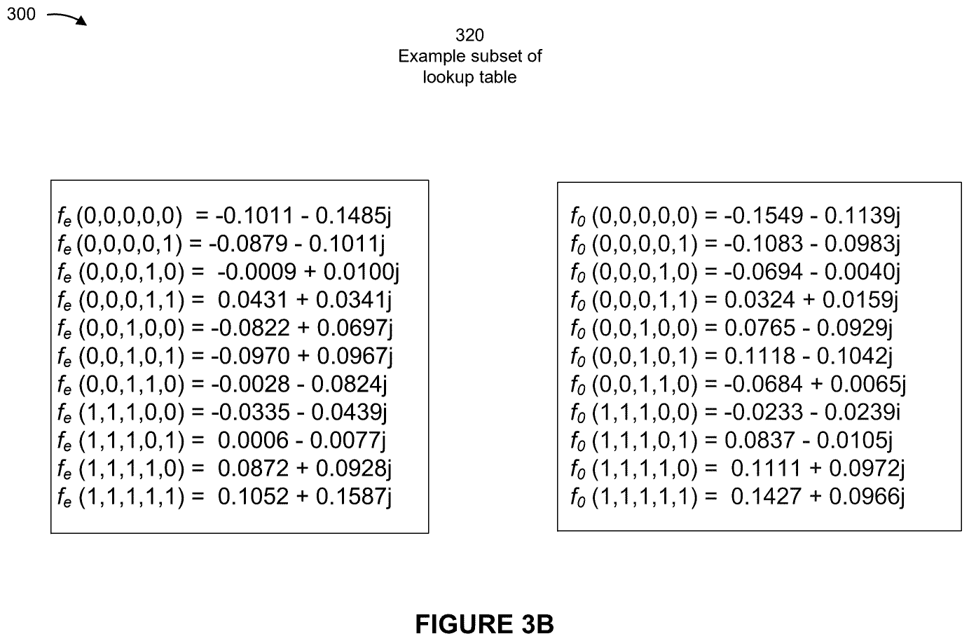

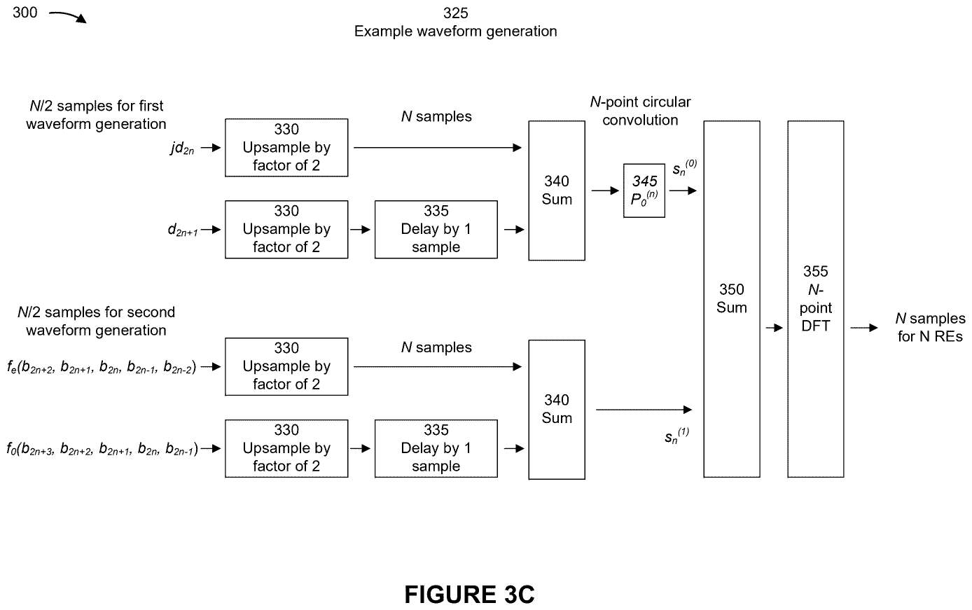

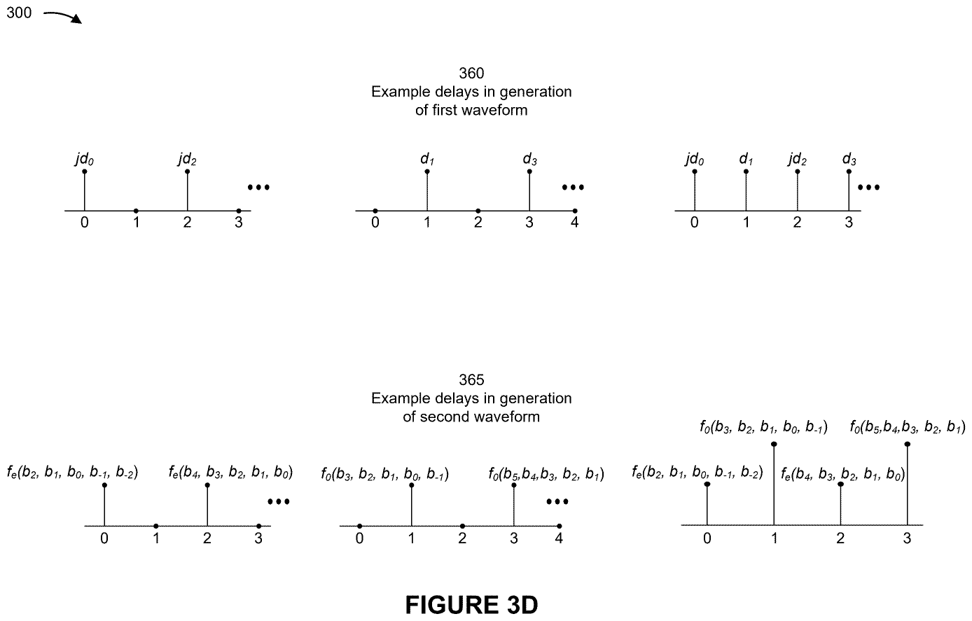

FIGS. 3A-3D are diagrams illustrating an example 300 associated with combined waveforms for signal modulation. As shown in FIG. 3A, example 300 includes communication between a transmitter (for example, a wireless communication device, including a network node 110 or a UE 120) and a receiver (for example, another wireless communication device, including a network node 110 or a UE 120). In some aspects, the transmitter and the receiver may be included in a wireless network, such as wireless network 100. The transmitter and the receiver may communicate via a wireless access link, which may include an uplink and a downlink.

In some aspects, as shown by reference number 305, the transmitter may generate a first waveform according to a π/2-BPSK modulation scheme that includes a first sequence delay for a sequence of even-numbered symbols that is up-sampled and rotated in phase by π/2, and a second sequence delay for a sequence of odd-numbered symbols that is up-sampled, wherein the first waveform has a first PAPR. In some aspects, generating the first waveform may include applying a pulse shaping filter to the sequence of even-numbered symbols and to the sequence of odd-numbered symbols. For example, the transmitter may use a digital filter to shape the pulse of each symbol prior to transmission. In this way, the π/2-BPSK modulation scheme may allow for efficient symbol transmission while maintaining the waveform's desired power ratio. Additionally, in some aspects, the first sequence delay may be less than the second sequence delay. For example, the transmitter may adjust timing configurations to prioritize certain sequences for transmission.

Additionally or alternatively, the first waveform may be generated using a circular convolution operation. For example, the transmitter may apply a convolution process to modulate the waveform's frequency domain characteristics.

In some aspects, the first waveform may be calculated using an equation of a form:

$${s}_{n}^{( 0 )} = \{ {\sum }_{l = 0}^{\frac{N}{2} - 1} ( j {d}_{2 l} δ ( n - 2 l ) + {d}_{2 l + 1} δ ( n - 2 l - 1 ) ) \} * {p}_{0} ( n ) ,$$

where

$${s}_{n}^{( 0 )}$$

is the first waveform, N is a quantity of coded bits to be transmitted, l is an integer, j is a unit imaginary number, a first symbol delay is 2l, a second symbol delay is 2l±1, d₂ₗ is a 2l^{th} BPSK symbol transmitted at the first symbol delay, d₂ₗ₊₁ is a (2l+1)th BPSK symbol transmitted at the second symbol delay, n is an integer time index ranging from 0 to N−1, * is an N-point circular convolution operator, δ(n) is a discrete time impulse function, and p₀(n) is a pulse shaping filter and is a function of n. Additionally or alternatively, the sequence of even-numbered symbols may include {d₀, d₂, d₄, . . . , d₂ₗ, . . . , d_{N-2}} and the sequence of odd-numbered symbols may include {d₁, d₃, d₅, . . . , d₂ₗ₊₁, . . . , d_{N-1}}. For example, the transmitter may organize symbols into distinct sequences for strategic waveform construction.

In some aspects, as shown by reference number 310, the transmitter may generate a second waveform according to a modulation scheme that includes applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled. For example, the transmitter may utilize complex value lookup tables to determine the functions applied to adjacent bits, which may then be up-sampled and delayed to form sequences that construct the second waveform. In this way, the modulation scheme may enable the reduction of the waveform's PAPR.

In some aspects, generating the pulse shaping filter p₀(n), the first function and the second function may involve using an ML algorithm. In some aspects, ML algorithms used for generating the pulse shaping filter p₀(n), the first and second functions may include supervised learning techniques, which may utilize a binary cross-entropy loss function based on transmitted coded bits, and a vector of received resource elements corresponding to the transmitted coded bits, the pulse shaping filter, the first function and the second function, in addition to a PAPR related objective function. The training process may involve iterative refinement of p₀(n), and the first function and the second function to minimize the binary cross-entropy and optimize waveform attributes, such as PAPR-related objective function. An example of the PAPR related objective function may be a weight sum of time domain sample powers,

$${ℒ}_{PAPR} = {\sum }_{n = 0}^{M} {w}_{n} {\vert {x}_{n} \vert}^{2} ,$$

where {xₙ} are oversampled time-domain samples of the transmitted waveform that is normalized such that E{|xₙ|²}=1, wₙ is a weight computed using a softmax function, given by

$${w}_{n} = \frac{{e}^{{\vert {x}_{n} \vert}^{2} / T}}{{\sum }_{n = 0}^{M} {e}^{{\vert {x}_{n} \vert}^{2} / T}} ,$$

T is a “temperature”, (for example T=0.1), and M is a quantity of generated time domain samples collected within a mini-batch. Lower temperature (for example, T=0.001) results in emphasizing the time domain samples with larger power. Generating the pulse shaping filter, the first function and the second function may involve using a gradient-based refinement procedure. More specifically, backpropagation used in the training of a neural network may be used to learn the pulse shaping filter, the first function and the second function. The pulse shaping filter, the first function and the second function may be implemented as learnable parameters. Employing gradient-based refinement may enable more precise tuning of waveform characteristics.

In some aspects, the first sequence of values may be derived from a first lookup table based on the even-numbered set of adjacent bits, and the second sequence of values may be derived from a second lookup table based on the odd-numbered set of adjacent bits. Additionally, in some aspects, each bit of the even-numbered set of adjacent bits and each bit of the odd-numbered set of adjacent bits may be obtained based on a set of coded bits to be communicated. For example, the transmitter may translate coded bits into symbol arrays for subsequent processing.

In some aspects, calculating the second waveform includes using an equation of a form

$${s}_{n}^{( 1 )} = \{ {\sum }_{l - 0}^{\frac{N}{2} - 1} ( {f}_{e} ( {b}_{2 l + 2} , {b}_{2 l + 1} , {b}_{2 l} , {b}_{2 l - 1} , {b}_{2 l - 2} ) δ ( n - 2 l ) + {f}_{0} ( {b}_{2 l + 3} , {b}_{2 l + 2} , {b}_{2 l + 1} , {b}_{2 l} , {b}_{2 l - 1} ) δ ( n - 2 l - 1 ) ) \} ,$$

where

$${s}_{n}^{( 1 )}$$

is the second waveform, N is a quantity of coded bits to be transmitted, l is an integer, a first symbol delay is 2l, a second symbol delay is 2l±1, {b₂ₗ₊₂, b₂ₗ₊₁, b₂ₗ, b₂ₗ₋₁, b₂ₗ₋₂} is a 2l-th set of adjacent bits, fₑ is the first function applied to an even-numbered set of adjacent bits, fₑ(b₂ₗ₊₂, b₂ₗ₊₁, b₂ₗ, b₂ₗ₋₁, b₂ₗ₋₂) is the value of the first function of the 2l-th set of adjacent bits transmitted at first symbol delay, {b₂ₗ₊₃, b₂ₗ₊₂, b₂ₗ₊₁, b₂ₗ, b₂ₗ₋₁} is a (2l+1)-th set of adjacent bits, fₒ is the second function applied to an odd-numbered set of adjacent bits, fₒ(b₂ₗ₊₃, b₂ₗ₊₂, b₂ₗ₊₁, b₂ₗ, b₂ₗ₋₁) is the value of the second function of the (2l+1)-th set of adjacent bits transmitted at the second symbol delay, n is an integer time index ranging from 0 to N−1, and δ(n) is a discrete time impulse function.

Additionally, in some aspects, fₑ(b₂ₗ₊₂, b₂ₗ₊₁, b₂ₗ, b₂ₗ₋₁, b₂ₗ₋₂) and fₒ(b₂ₗ₊₃, b₂ₗ₊₂, b₂ₗ₊₁, b₂ₗ, b₂ₗ₋₁) may be complex valued lookup tables with five-bit inputs. For example, as shown in FIG. 3B, and by reference number 320, an example subset of a lookup table is shown for an example subset of fₑ inputs and an example subset of fₒ inputs. Additionally or alternatively, calculating the second waveform may use the defined equation parameters to ensure accurate modulation of adjacent bit sequences.

For example, the lookup tables (fₑ and fₒ) employed in the modulation scheme may be constructed based on a gradient-based optimization method (for example, backpropagation) applied to a PAPR-related objective evaluated on various communication scenarios (for example, the number of the resource blocks allocated for uplink transmission). These tables fₑ and fₒ may be implemented as learnable parameters similar to neural network weights to enable backpropagation based optimization. These tables may include mappings of bit sequences to modulation values that have been determined to reduce PAPR effectively. For example, lookup tables may be constructed based on selecting representative bit sequences and corresponding modulation outputs, which may then be stored for access during signal processing.

In some aspects, as shown by reference number 315 in FIG. 3A, the transmitter may transmit, and the receiver may receive, a composite waveform that combines the first waveform and the second waveform, wherein the composite waveform has a second PAPR that is less than the first PAPR. For example, by summing the two waveforms, the transmitter creates a composite signal ready for transmission that exhibits a lower PAPR as compared to the individual first waveform. In this way, the second waveform may reduce the PAPR of the first waveform when the second waveform is added to (for example, combined with) the first waveform.

In some aspects, combining the first waveform and the second waveform may include summing the first waveform and the second waveform to obtain the composite waveform. In some aspects, combining the first waveform and the second waveform may include performing a DFT on the summed waveform according to a quantity (for example, N) of REs for transmitting the composite waveform.

For example, waveform construction for the π/2 BPSK waveform may include N coded bits to be transmitted for N REs, given by bₙ∈{0,1}, for n=0, 1, . . . , N−1. The corresponding BPSK symbols dₙ∈{−1,1} are generated according to dₙ=1−2bₙ, where bₙ may be periodic with a period N such that b_{n+kN}=bₙ for any integer k. In this way, the waveform in the time domain may be constructed as the sum of two waveforms (for n=0, 1, . . . , N−1), given by

$${s}_{n} = {s}_{n}^{( 0 )} + {s}_{n}^{( 1 )} ,$$

where sₙ is the combined (for example, composite) waveform,

$${s}_{n}^{( 0 )}$$

is the first waveform, and

$${s}_{n}^{( 1 )}$$

is the second waveform.

In some aspects, the composite waveform may be transmitted over a quantity of REs. Additionally, in some aspects, the composite waveform may include a quantity of samples transmitted over the quantity of REs, wherein one or more samples are assigned a value of zero. For example, one or more of the samples at the output of the N-point DFT may be zeroed-out. In other words, K samples at the output of N-point DFT may be “punctured”, where K is smaller than N.

As shown in FIG. 3C, and by reference number 325, the wireless communication device (for example, a UE 120 or a network node 110) may generate a first waveform,

$${s}_{n}^{( 0 )} ,$$

and a second waveform,

$${s}_{n}^{( 1 )} ,$$

and the transmitter may combine the first waveform and the second waveform to generate a composite waveform. In some aspects, b₋₁:=b_{N-1} and b₋₂:=b_{N-2}.

As shown by reference number 330, the wireless communication device may up-sample samples related to the first waveform and to the second waveform by a factor of 2. For example, the wireless communication device may process N/2 samples for the first waveform generation (for example, jd₂ₙ for a 2n^{th} BPSK symbol rotated in phase by π/2 transmitted at a first symbol delay given by 2n, and d₂ₙ₊₁ for a (2n+1)^{th} BPSK symbol transmitted at a second symbol delay given by 2n+1). Additionally, the wireless communication device may process N/2 samples for the second waveform generation (for example, fₑ(b₂ₙ₊₂, b₂ₙ₊₁, b₂ₙ, b₂ₙ₋₁, b₂ₙ₋₂) for the value of the first function of the 2n^{th} set of adjacent bits transmitted at the first symbol delay given by 2n, and fₒ(b₂ₙ₊₃, b₂ₙ₊₂, b₂ₙ₊₁, b₂ₙ, b₂ₙ₋₁) for the value of the second function of the (2n+1)^{th} set of adjacent bits transmitted at the second symbol delay given by 2n+1.

As shown by reference number 335, after up-sampling, the wireless communication device may apply a sequence delay of one sample. For example, after up-sampling, the wireless communication device may apply a first sequence delay of zero samples to a sequence of even-numbered BPSK symbols rotated in phase by π/2 (for example, the zeroth BPSK symbol rotated in phase by π/2, the second BPSK symbol rotated in phase by π/2, and so on), and the wireless communication device may apply the first sequence delay of zero samples to a first sequence of values, each value in the first sequence of values being the first function of an even-numbered set of adjacent bits (for example the zeroth set of adjacent bits, the second set of adjacent bits, and so on). As a further example, after up-sampling, the wireless communication device may apply a second sequence delay of one sample to the sequence of odd-numbered BPSK symbols (for example, the first BPSK symbol, the third BPSK symbol, and so on), and the wireless communication device may apply the second sequency delay of one sample to a second sequence of values, each value in the second sequence of values being the second function of an odd-numbered set of adjacent bits (for example, the first set of adjacent bits, the third set of adjacent bits, and so on).

As shown by reference number 340, the wireless communication device may sum the respective sequences. For example, the device may combine the up-sampled and delayed sequences for subsequent processing.

As shown by reference number 345, the wireless communication device may perform an N-point circular convolution with respect to the first waveform. In some aspects, the wireless communication device may apply a pulse shaping filter, denoted Po (n). For example, applying the pulse shaping filter may modulate the waveform's characteristics, enabling reduced spectral interference and improved signal integrity.

As shown by reference number 350, the wireless communication device may sum the first waveform,

$${s}_{n}^{( 0 )} ,$$

and the second waveform,

$${s}_{n}^{( 1 )} .$$

As shown by reference number 355, the wireless communication device may perform an N-point DFT on the summed waveforms in order to create a composite waveform. In this way, combining the first waveform and the second waveform creates a waveform with reduced PAPR, relative to the first waveform.

As shown in FIG. 3D, and by reference number 360, an example implementation is illustrated for sample delays related to generation of the first waveform. For example, after up-sampling, jd₂ₗ may be sent on an even delay given by 2l, and d₂ₗ₊₁ may be sent on an odd delay given by 2l+1. Furthermore, as shown by reference number 365, an example implementation is illustrated for sample delays related to generation of the second waveform. For example, after upsampling, the value of the first function of the 2l^{th} set of adjacent bits may be transmitted at an even delay given by 2l, and the value of the second function of the (2l+1)^{th} set of adjacent bits transmitted at an odd delay given by 2l+1.

As described herein, the composite waveform formed by combination of the first waveform and the second waveform enables a reduction in PAPR. In some aspects, a wireless communication device may construct a combined waveform based on a π/2-BPSK modulation scheme by combining two waveforms to achieve lower PAPR. The first waveform is generated according to a π/2-BPSK modulation scheme, which includes a first sequence delay for a sequence of even-numbered symbols that is up-sampled and rotated in phase by π/2, and a second sequence delay for a sequence of odd-numbered symbols that is up-sampled. The second waveform further reduces PAPR by employing modulation schemes that include applying first and second functions to sets of adjacent bits (for example, related to lookup tables), and up-sampling these values.

By generating and combining the first and second waveforms as described, the techniques can effectively reduce the PAPR of the transmitted signal. This reduction in PAPR enhances power efficiency and reduces the likelihood of signal distortion during transmission, thereby maintaining high signal integrity, especially in low SNR environments or when operating with limited power budgets. In this way, communicating using the combined waveform may conserve power resources and improve signal integrity in wireless communication systems.

FIG. 4 is a flowchart illustrating an example process 400 performed, for example, at a wireless communication device (for example, UE 120 or network node 110) or an apparatus of a wireless communication device that supports combined waveforms for signal modulation. Example process 400 is an example where the apparatus or the wireless communication device (for example, UE 120 or network node 110) performs operations associated with combined waveforms for signal modulation.

As shown in FIG. 4, in some aspects, process 400 may include generating a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled (block 410). For example, the wireless communication device (such as by using communication manager 150, communication manager 155, or waveform generation component 510, depicted in FIG. 5) may generate a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled, as described above.

As further shown in FIG. 4, in some aspects, process 400 may include generating a second waveform by: applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted (block 420). For example, the wireless communication device (such as by using communication manager 150, communication manager 155, or waveform generation component 510, depicted in FIG. 5) may generate a second waveform by: applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted, as described above.

As further shown in FIG. 4, in some aspects, process 400 may include transmitting a composite waveform that includes the first waveform and the second waveform (block 430). For example, the wireless communication device (such as by using communication manager 150, communication manager 155, or transmission component 504, depicted in FIG. 5) may transmit a composite waveform that combines the first waveform and the second waveform, as described above.

Process 400 may include additional aspects, such as any single aspect or any combination of aspects described below or in connection with one or more other processes described elsewhere herein.

In a first additional aspect, process 400 includes summing the first waveform and the second waveform to obtain a summed waveform, and performing a DFT on the summed waveform according to a quantity of REs for transmitting the composite waveform, to obtain the composite waveform.

In a second additional aspect, alone or in combination with the first aspect, generating the first waveform includes applying a pulse shaping filter to the sequence of even-numbered symbols and to the sequence of odd-numbered symbols.

In a third additional aspect, alone or in combination with one or more of the first through second aspects, process 400 includes generating the first function and the second function using an ML algorithm, wherein the ML algorithm utilizes a gradient-based refinement procedure in accordance with one or more iterative adjustments to a set of parameters of an objective function.

In a fourth additional aspect, alone or in combination with one or more of the first through third aspects, the first sequence delay is less than the second sequence delay.

In a fifth additional aspect, alone or in combination with one or more of the first through fourth aspects, the first sequence of values are derived from a first lookup table based on the even-numbered set of adjacent bits, and the second sequence of values are derived from a second lookup table based on the odd-numbered set of adjacent bits.

In an sixth additional aspect, alone or in combination with one or more of the first through fifth aspects, the composite waveform is transmitted over a quantity of resource elements that is equal to a quantity of bits to be transmitted.

In a seventh additional aspect, alone or in combination with one or more of the first through sixth aspects, the composite waveform includes a quantity of samples transmitted over the quantity of resource elements, and one or more samples, of the quantity of samples, are punctured.

In an eighth additional aspect, alone or in combination with one or more of the first through seventh aspects, generating the first waveform includes applying a circular convolution operation to the sequence of even-numbered symbols and the sequence of odd numbers symbols.

In a ninth additional aspect, alone or in combination with one or more of the first through eighth aspects, process 400 includes calculating the first waveform using an equation of a form

$${s}_{n}^{( 0 )} = \{ {\sum }_{l = 0}^{\frac{N}{2} - 1} ( {jd}_{2 l} δ ( n - 2 l ) + {d}_{2 l + 1} δ ( n - 2 l - 1 ) ) \} * {p}_{0} ( n ) ,$$

where

$${s}_{n}^{( 0 )}$$

is the first waveform, N is a quantity of coded bits to be transmitted, l is an integer, j is a unit imaginary number, a first symbol delay is 2l, a second symbol delay is 2l±1, d₂ₗ is a 2l^{th} BPSK symbol transmitted at the first symbol delay, d₂ₗ₊₁ is a (2l+1)^{th} BPSK symbol transmitted at the second symbol delay, n is an integer time index ranging from 0 to N−1, * is an N-point circular convolution operator, δ(n) is a discrete time impulse function, and p₀(n) is a pulse shaping filter and is a function of n.

In a tenth additional aspect, alone or in combination with one or more of the first through ninth aspects, the sequence of even-numbered symbols includes {d₀, d₂, d₄, . . . , d₂ₗ, . . . , d_{N-2}} and the sequence of odd-numbered symbols includes {d₁, d₃, d₅, . . . , d₂ₗ₊₁, . . . , d_{N-1}}.

In a eleventh additional aspect, alone or in combination with one or more of the first through tenth aspects, process 400 includes calculating the second waveform using an equation of a form

$${s}_{n}^{( 1 )} = \{ {\sum }_{l = 0}^{\frac{N}{2} - 1} ( {f}_{e} ( {b}_{2 l + 2} , {b}_{2 l + 1} , {b}_{2 l} , {b}_{2 l - 1} , {b}_{2 l - 2} ) δ ( n - 2 l ) + {f}_{o} ( {b}_{2 l + 3} , {b}_{2 l + 2} , {b}_{2 l + 1} , {b}_{2 l} , {b}_{2 l - 1} ) δ ( n - 2 l - 1 ) ) \} ,$$

where

$${s}_{n}^{( 1 )}$$

is the second waveform, N is a quantity of coded bits to be transmitted, l is an integer, a first symbol delay is 2l, a second symbol delay is 2l+1, {b₂ₗ₊₂, b₂ₗ₊₁, b₂l, b₂ₗ₋₁, b₂ₗ₋₂} is a 2l-th set of adjacent bits, fₑ is the first function applied to an even-numbered set of adjacent bits, fₑ(b₂ₗ₊₂, b₂ₗ₊₁, b₂ₗ, b₂ₗ₋₁, b₂ₗ₋₂) is the value of the first function of the 2l-th set of adjacent bits transmitted at first symbol delay, {b₂ₗ₊₃, b₂ₗ₊₂, b₂ₗ₊₁, b₂ₗ, b₂ₗ₋₁} is a (2l+1)-th set of adjacent bits, fₒ is the second function applied to an odd-numbered set of adjacent bits, fₒ(b₂ₗ₊₃, b₂ₗ₊₂, b₂ₗ₊₁, b₂ₗ, b₂ₗ₋₁) is the value of the second function of the (2l+1)-th set of adjacent bits transmitted at the second symbol delay, n is an integer time index ranging from 0 to N−1, and δ(n) is a discrete time impulse function.

Although FIG. 4 shows example blocks of process 400, in some aspects, process 400 may include additional blocks, fewer blocks, different blocks, or differently arranged blocks than those depicted in FIG. 4. Additionally or alternatively, two or more of the blocks of process 400 may be performed in parallel.

FIG. 5 is a diagram of an example apparatus 500 for wireless communication that supports combined waveforms for signal modulation. The apparatus 500 may be a wireless communication device (for example, UE 120 or network node 110), or a wireless communication device (for example, UE 120 or network node 110) may include the apparatus 500. In some aspects, the apparatus 500 includes a reception component 502, a transmission component 504, and a communication manager 506, which may be in communication with one another (for example, via one or more buses). As shown, the apparatus 500 may communicate with another apparatus 508 (such as a UE 120, a network node 110, or another wireless communication device) using the reception component 502 and the transmission component 504. The communication manager 506 may be included in, or implemented via, a processing system (for example, the processing system 140 or the processing system 145). In some aspects, the communication manager 506 is the communication manager 150 or the communication manager 155.

In some aspects, the apparatus 500 may be configured to or operable to perform one or more operations described herein in connection with FIGS. 3A-3D. Additionally or alternatively, the apparatus 500 may be configured to or operable to perform one or more processes described herein, such as process 400 of FIG. 4.

The reception component 502 may receive communications, such as reference signals, control information, or data communications, from the apparatus 508. The reception component 502 may provide received communications to one or more other components of the apparatus 500, such as the communication manager 506. In some aspects, the reception component 502 may perform signal processing on the received communications, and may provide the processed signals to the one or more other components in a similar manner as described above in connection with FIG. 1. In some aspects, the reception component 502 may include one or more components of the UE or the network node described above in connection with FIG. 1, such as a radio, one or more RF chains, one or more transceivers, or one or more modems, each of which may in turn be coupled with one or more antennas of the UE or the network node.

The transmission component 504 may transmit communications, such as reference signals, control information, or data communications, to the apparatus 508. In some aspects, the communication manager 506 may generate communications and may transmit the generated communications to the transmission component 504 for transmission to the apparatus 508. In some aspects, the transmission component 504 may perform signal processing on the generated communications, and may transmit the processed signals to the apparatus 508 in a similar manner as described above in connection with FIG. 1. In some aspects, the transmission component 504 may include one or more components of the UE or the network node described above in connection with FIG. 1, such as a radio, one or more RF chains, one or more transceivers, or one or more modems, each of which may in turn be coupled with one or more antennas of the UE or the network node. In some aspects, the transmission component 504 may be co-located with the reception component 502.

The communication manager 506 may generate a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled. The communication manager 506 may generate a second waveform according to a modulation scheme that includes applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted. The communication manager 506 may transmit or may cause the transmission component 504 to transmit a composite waveform that includes the first waveform and the second waveform. In some aspects, the communication manager 506 may perform one or more operations described elsewhere herein as being performed by one or more components of the communication manager 506.

In some aspects, the communication manager 506 includes a set of components, such as a waveform generation component 510, or a waveform combination component 512. Alternatively, the set of components may be separate and distinct from the communication manager 506. As used herein, the term “component” is intended to be broadly construed as hardware or a combination of hardware and at least one of software or firmware. In some aspects, one or more components of the set of components may include or may be implemented within a processing system (for example, the processing system 140 or the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The waveform generation component 510 may generate a first waveform according to a π/2-BPSK modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled. The waveform generation component 510 may generate a second waveform according to a modulation scheme that includes applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted. The transmission component 504 may transmit a composite waveform that includes the first waveform and the second waveform.

The waveform combination component 512 may combine the first waveform and the second waveform to obtain the composite waveform.

The waveform generation component 510 may generate the first function and the second function using an ML algorithm, wherein the ML algorithm utilizes a gradient-based refinement procedure in accordance with one or more iterative adjustments to a set of parameters of an objective function.

The quantity and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally or alternatively, a set of (one or more) components shown in FIG. 5 may perform one or more functions described as being performed by another set of components shown in FIG. 5.

The following provides an overview of some Aspects of the present disclosure:
Aspect 1: A method for wireless communication by a wireless communication device, comprising: generating a first waveform according to a π/2-binary phase shift keying (BPSK) modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled; generating a second waveform according to a modulation scheme that includes: applying the first sequence delay to a first sequence of values, each value in the first sequence of values being a first function of an even-numbered set of adjacent bits that is up-sampled, and applying the second sequence delay to a second sequence of values, each value in the second sequence of values being a second function of an odd-numbered set of adjacent bits that is up-sampled, wherein the ML algorithm utilizes a gradient-based refinement procedure in accordance with one or more iterative adjustments to a set of parameters of an objective function; and transmitting a composite waveform that includes the first waveform and the second waveform.
Aspect 2: The method of Aspect 1, further comprising: combining the first waveform and the second waveform to obtain the composite waveform.
Aspect 3: The method of Aspect 2, wherein combining the first waveform and the second waveform comprises: summing the first waveform and the second waveform to obtain a summed waveform; and performing a discrete Fourier transform on the summed waveform according to a quantity of resource elements for transmitting the composite waveform, to obtain the composite waveform.
Aspect 4: The method of any of Aspects 1-3, wherein generating the first waveform includes applying a pulse shaping filter to the sequence of even-numbered symbols and to the sequence of odd-numbered symbols.
Aspect 5: The method of any of Aspects 1-4, further comprising: generating the first function and the second function using an ML algorithm, wherein the ML algorithm utilizes a gradient-based refinement procedure in accordance with one or more iterative adjustments to a set of parameters of an objective function.
Aspect 6: The method of any of Aspects 1-5, further comprising: generating the first function and the second function using a gradient-based refinement procedure.
Aspect 7: The method of any of Aspects 1-6, wherein the first sequence delay is less than the second sequence delay.
Aspect 8: The method of any of Aspects 1-7, wherein the first sequence of values are derived from a first lookup table based on the even-numbered set of adjacent bits, and the second sequence of values are derived from a second lookup table based on the odd-numbered set of adjacent bits.
Aspect 9: The method of any of Aspects 1-8, wherein the composite waveform is transmitted over a quantity of resource elements that is equal to a quantity of bits to be transmitted.
Aspect 10: The method of any of Aspects 1-9, wherein the composite waveform includes a quantity of samples transmitted over the quantity of resource elements, and wherein one or more samples, of the quantity of samples, are punctured.
Aspect 11: The method of any of Aspects 1-10, wherein generating the first waveform includes applying a circular convolution operation to the sequence of even-numbered symbols and the sequence of odd-numbered symbols.
Aspect 12: The method of any of Aspects 1-11, wherein each bit of the even-numbered set of adjacent bits and each bit of the odd-numbered set of adjacent bits is obtained based on a set of coded bits to be communicated.
Aspect 13: The method of any of Aspects 1-12, further comprising: calculating the first waveform using an equation of a form

$${s}_{n}^{( 0 )} = \{ {\sum }_{l = 0}^{\frac{N}{2} - 1} ( {jd}_{2 l} δ ( n - 2 l ) + {d}_{2 l + 1} δ ( n - 2 l - 1 ) ) \} * {p}_{0} ( n ) ,$$

where

$${s}_{n}^{( 0 )}$$

is the first waveform, N is a quantity of coded bits to be transmitted, l is an integer, j is a unit imaginary number, a first symbol delay is 2l, a second symbol delay is 2l±1, d₂ₗ is a 2l^{th} BPSK symbol transmitted at the first symbol delay, d₂ₗ₊₁ is a (2l+1)th BPSK symbol transmitted at the second symbol delay, n is an integer time index ranging from 0 to N−1, * is an N-point circular convolution operator, δ(n) is a discrete time impulse function, and p₀(n) is a pulse shaping filter and is a function of n.
Aspect 14: The method of Aspect 13, wherein the sequence of even-numbered symbols includes {d₀, d₂, d₄, . . . , d₂ₗ, . . . , d_{N-2}} and the sequence of odd-numbered symbols includes {d₁, d₃, d₅, . . . , d₂ₗ₊₁, . . . , d_{N-1}}.
Aspect 15: The method of any of Aspects 1-14, further comprising: calculating the second waveform using an equation of a form

$${s}_{n}^{( 1 )} = \{ {\sum }_{l = 0}^{\frac{N}{2} - 1} ( {f}_{e} ( {b}_{2 l + 2} , {b}_{2 l + 1} , {b}_{2 l} , {b}_{2 l - 1} , {b}_{2 l - 2} ) δ ( n - 2 l ) + {f}_{o} ( {b}_{2 l + 3} , {b}_{2 l + 2} , {b}_{2 l + 1} , {b}_{2 l} , {b}_{2 l - 1} ) δ ( n - 2 l - 1 ) ) \} ,$$

where

$${s}_{n}^{( 1 )}$$

is the second waveform, N is a quantity of coded bits to be transmitted, l is an integer, a first symbol delay is 2l, a second symbol delay is 2l+1, {b₂ₗ₊₂, b₂ₗ₊₁, b₂ₗ, b₂ₗ₋₁, b₂ₗ₋₂} is a 2l-th set of adjacent bits, fₑ is the first function applied to an even-numbered set of adjacent bits, fₑ(b₂ₗ₊₂, b₂ₗ₊₁, b₂ₗ, b₂ₗ₋₁, b₂ₗ₋₂) is the value of the first function of the 2l-th set of adjacent bits transmitted at first symbol delay, {b₂ₗ₊₃, b₂ₗ₊₂, b₂ₗ₊₁, b₂ₗ, b₂ₗ₋₁} is a (2l+1)-th set of adjacent bits, fₒ is the second function applied to an odd-numbered set of adjacent bits, fₒ(b₂ₗ₊₃, b₂ₗ₊₂, b₂ₗ₊₁, b₂ₗ, b₂ₗ₋₁) is the value of the second function of the (2l+1)-th set of adjacent bits transmitted at the second symbol delay, n is an integer time index ranging from 0 to N−1, and δ(n) is a discrete time impulse function.
Aspect 15: An apparatus for wireless communication at a device, the apparatus comprising one or more memories and one or more processors coupled to the one or more memories, the one or more processors configured to cause the device to perform the method of one or more of Aspects 1-15.
Aspect 16: An apparatus for wireless communication, the apparatus comprising at least one means for performing the method of one or more of Aspects 1-15.
Aspect 17: A non-transitory computer-readable medium storing code for wireless communication, the code comprising instructions executable by one or more processors to perform the method of one or more of Aspects 1-15.
Aspect 18: A non-transitory computer-readable medium storing a set of instructions for wireless communication, the set of instructions comprising one or more instructions that, when executed by one or more processors of a device, cause the device to perform the method of one or more of Aspects 1-15.
Aspect 19: A device for wireless communication, the device comprising a processing system that includes one or more processors and one or more memories coupled with the one or more processors, the processing system configured to cause the device to perform the method of one or more of Aspects 1-15.
Aspect 20: An apparatus for wireless communication at a device, the apparatus comprising one or more memories and one or more processors coupled to the one or more memories, the one or more processors individually or collectively configured to cause the device to perform the method of one or more of Aspects 1-15.
Aspect 21: A device comprising a processing system that includes one or more processors and one or more code-storing memories coupled with the one or more processors, the processing system configured to cause the device to perform the method of one or more of Aspects 1-15.
Aspect 22: A device comprising a processing system that includes processor circuitry and code-storing memory circuitry, the processing system configured to cause the device to perform the method of one or more of Aspects 1-15.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A wireless communication device, comprising:
a processing system that includes one or more processors and one or more code-storing memories coupled with the one or more processors, the processing system configured to cause the wireless communication device to:
generate a first waveform according to a π/2-binary phase shift keying (BPSK) modulation scheme that include applying a first sequence delay for a sequence of even-numbered symbols, of the first waveform, that is up-sampled and rotated in phase by π/2, and a second sequence delay for a sequence of odd-numbered symbols, of the first waveform, that is up-sampled;
generate a second waveform by:
applying the first sequence delay to a first sequence of values, each value in the first sequence of values being a first function of an even-numbered set of adjacent bits that is up-sampled, and
applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted; and
transmit a composite waveform that includes the first waveform and the second waveform.

2. The wireless communication device of claim 1, wherein transmitting the composite waveform includes:
summing the first waveform and the second waveform to obtain a summed waveform; and
performing a discrete Fourier transform on the summed waveform according to a quantity of resource elements for transmitting the composite waveform, to obtain the composite waveform.

3. The wireless communication device of claim 2, wherein the composite waveform includes a quantity of samples transmitted over the quantity of resource elements, and
wherein one or more samples, of the quantity of samples, are punctured.

4. The wireless communication device of claim 1, wherein generating the first waveform includes applying a pulse shaping filter to the sequence of even-numbered symbols and to the sequence of odd-numbered symbols.

5. The wireless communication device of claim 1, wherein the processing system is configured to cause the wireless communication device to:
generate the first function and the second function using a machine learning (ML) algorithm, wherein the ML algorithm utilizes a gradient-based refinement procedure in accordance with one or more iterative adjustments to a set of parameters of an objective function.

6. The wireless communication device of claim 1, wherein the first sequence delay is less than the second sequence delay.

7. The wireless communication device of claim 1, wherein the first sequence of values are derived from a first lookup table based on the even-numbered set of adjacent bits, and the second sequence of values are derived from a second lookup table based on the odd-numbered set of adjacent bits.

8. The wireless communication device of claim 1, wherein the composite waveform is transmitted over a quantity of resource elements that is equal to a quantity of bits to be transmitted.

9. The wireless communication device of claim 1, wherein generating the first waveform includes applying a circular convolution operation to the sequence of even-numbered symbols and the sequence of odd-numbered symbols.

10. The wireless communication device of claim 1, wherein the processing system is configured to cause the wireless communication device to:
calculate the first waveform using an equation of a form
$${s}_{n}^{( 0 )} = \{ {\sum }_{l = 0}^{\frac{N}{2} - 1} ( {jd}_{2 l} δ ( n - 2 l ) + {d}_{2 l + 1} δ ( n - 2 l - 1 ) ) \} * {p}_{0} ( n ) ,$$
wherein:
$${s}_{n}^{( 0 )}$$
is the first waveform,
N is a quantity of coded bits to be transmitted,
l is an integer,
j is a unit imaginary number,
a first symbol delay is 2l,
a second symbol delay is 2l+1,
d₂ₗ is a 2l^{th} BPSK symbol transmitted at the first symbol delay,
d₂ₗ₊₁ is a (2l+1)^{th} BPSK symbol transmitted at the second symbol delay,
n is an integer time index ranging from 0 to N−1,
* is an N-point circular convolution operator,
δ(n) is a discrete time impulse function, and
p₀(n) is a pulse shaping filter and is a function of n.

11. The wireless communication device of claim 10, wherein the sequence of even-numbered symbols includes {d₀, d₂, d₄, . . . , d₂ₗ, . . . , d_{N-2}} and the sequence of odd-numbered symbols includes {d₁, d₃, d₅, . . . , d₂ₗ₊₁, . . . , d_{N-1}}.

12. The wireless communication device of claim 1, wherein the processing system is configured to cause the wireless communication device to:
calculate the second waveform using an equation of a form
$${s}_{n}^{( 1 )} = \{ {\sum }_{l = 0}^{\frac{N}{2} - 1} ( {f}_{e} ( {b}_{2 l + 2} , {b}_{2 l + 1} , {b}_{2 l} , {b}_{2 l - 1} , {b}_{2 l - 2} ) δ ( n - 2 l ) + {f}_{o} ( {b}_{2 l + 3} , {b}_{2 l + 2} , {b}_{2 l + 1} , {b}_{2 l} , {b}_{2 l - 1} ) δ ( n - 2 l - 1 ) ) \} ,$$
wherein:
$${s}_{n}^{( 1 )}$$
is the second waveform,
N is a quantity of coded bits to be transmitted,
l is an integer,
a first symbol delay is 2l,
a second symbol delay is 2l±1,
{b₂ₗ₊₂, b₂ₗ₊₁, b₂ₗ, b₂ₗ₋₁, b₂ₗ₋₂} is a 2l-th set of adjacent bits,
fₑ is the first function applied to an even-numbered set of adjacent bits,
fₑ(b₂ₗ₊₂, b₂ₗ₊₁, b₂ₗ, b₂ₗ₋₁, b₂ₗ₋₂) is the value of the first function of the 2l-th set of adjacent bits transmitted at the first symbol delay,
{b₂ₗ₊₃, b₂ₗ₊₂, b₂ₗ₊₁, b₂ₗ, b₂ₗ₋₁} is a (2l+1)-th set of adjacent bits,
fₒ is the second function applied to an odd-numbered set of adjacent bits,
fₒ(b₂ₗ₊₃, b₂ₗ₊₂, b₂ₗ₊₁, b₂ₗ, b₂ₗ₋₁) is the value of the second function of the (2l+1)-th set of adjacent bits transmitted at the second symbol delay,
n is an integer time index ranging from 0 to N−1, and
δ(n) is a discrete time impulse function.

13. The wireless communication device of claim 1, wherein the sequence of even-numbered samples and the sequence of odd-numbered samples are up-sampled in accordance with an up-sampling configuration obtained by the wireless communication device.

14. A method for wireless communication by a wireless communication device, comprising:
generating a first waveform according to a π/2-binary phase shift keying (BPSK) modulation scheme that includes applying a first sequence delay for a sequence of even-numbered symbols, of the first waveform, that is up-sampled and rotated in phase by π/2, and a second sequence delay for a sequence of odd-numbered symbols, of the first waveform, that is up-sampled;
generating a second waveform by:
applying the first sequence delay to a first sequence of values, each value in the first sequence of values being a first function of an even-numbered set of adjacent bits that is up-sampled, and
applying the second sequence delay to a second sequence of values, each value in the second sequence of values being a second function of an odd-numbered set of adjacent bits that is up-sampled, wherein each bit of the even-numbered set of adjacent bits and each bit of the odd-numbered set of adjacent bits is obtained based on a set of coded bits to be transmitted; and
transmitting a composite waveform that includes the first waveform and the second waveform.

15. The method of claim 14, wherein generating the first waveform includes applying a pulse shaping filter to the sequence of even-numbered symbols and to the sequence of odd-numbered symbols.

16. The method of claim 14, wherein the first sequence delay is less than the second sequence delay.

17. The method of claim 14, wherein the first sequence of values are derived from a first lookup table based on the even-numbered set of adjacent bits, and the second sequence of values are derived from a second lookup table based on the odd-numbered set of adjacent bits.

18. The method of claim 14, wherein transmitting the composite waveform includes:
summing the first waveform and the second waveform to obtain a summed waveform; and
performing a discrete Fourier transform on the summed waveform according to a quantity of resource elements for transmitting the composite waveform, to obtain the composite waveform.

19. The method of claim 14, wherein the composite waveform is transmitted over a quantity of resource elements that is equal to a quantity of bits to be transmitted.

20. The method of claim 14, wherein generating the first waveform includes applying a circular convolution operation to the sequence of even-numbered symbols and the sequence of odd-numbered symbols.
